(19) United States
(12) Patent Application Publication
(10) Pub. No.: US 2024/0315472 A1
(43) Pub. Date: Sep. 26, 2024

(54) CROCKERY SYSTEM COMPRISING THERMAL BUFFER MATERIAL AND PHASE- CHANGE MATERIAL

(71) Applicant: PROMECO NV, Kortrijk (BE)

(72) Inventors: Karim REDJAL, ZWEVEGEM (BE); Pascal Gabriëlle Nestor MERTENS, HERNE (BE)

(21) Appl. No.: 18/577,878

(22) PCT Filed: Jul. 8, 2022
(86) PCT No.: PCT/IB2022/056332

§ 371 Date: Jan. 9, 2024

(30) Foreign Application Priority Data
Jul. 9, 2021 (BE) 2021/5536

(51) Int. Cl. A47G 23/06; F25D 3/08

(52) U.S. Cl. CPC A47G 23/0683; F25D 3/08; F25D 2303/0845

(57) ABSTRACT

Crockery system comprising at least one serving dish (130), at least one form-flexible package comprising liquid thermal buffer material (120), and at least one optionally form-retaining package comprising phase-change material (110), wherein the at least one package comprising thermal buffer material is in thermal contact on the upper side thereof with the at least one serving dish and is in thermal contact on the underside thereof with the at least one package comprising phase-change material.

### FIELD OF THE INVENTION

The invention relates to a crockery system comprising a surface on which food can be placed, and a thermal buffer material, and a phase-change material. The invention further relates to methods for producing and using a crockery system comprising a thermal buffer material and a phase-change material.

### BACKGROUND

Several patents are known which are related to the application of phase-change materials contained in crockery for keeping food placed on or in the crockery cooled or hot, this by means of the latent energy which can be activated by respective solidification or melting of the phase-change material contained in the crockery and which can be transferred through a surface of the crockery after activation of the phase-change material, typically by transfer via conduction of the thermal energy, to the food to be kept cooled or hot.

If the stated application relates to keeping food cold, the necessary activation of the phase-change material, this being the phase transition from liquid to solid state, is typically achieved by placing the phase-change material in an environment with a temperature lower than the solidification point of the phase-change material. The solidification temperatures relevant thereto, for the phase transition and for the cooling of the food, lie in the temperature range of −15° to 15° C., these being temperatures which are typically lower than the ambient temperature of an environment in which the food is consumed or, more generally, typical everyday surroundings, and as a result, freezers, typically with a temperature in the range of −5° C. to −20° C., and refrigerators, typically with a temperature in the range of 1° C. to 7° C., can be suitable for activation of these phase-change materials, for which activation times of between 3 hours and 12 hours are typically needed.

In the case of application for keeping food warm the necessary activation, this being the phase transition from solid to liquid state, is achieved by placing the phase-change material, with a melting point typically in the temperature range of 35 to 95° C., in an environment with a temperature higher than the melting point of the phase-change material. A heating cabinet with a temperature set to 90° C. or an oven set to a temperature of 120° C. can thus for instance be suitable for melting such phase-change material, with necessary activation times typically lying between 1 hour and 12 hours.

To keep food cool in for instance a buffet, use is typically made as crockery system of a setup consisting of one or more serving dishes, typically having as their material stainless steel or porcelain and having dimensions typically corresponding with a selection from GastroNorm (GN) dimensioning, supporting on a carrier vessel, typically of stainless steel, having in the vessel one or more cooling elements consisting of a phase-change material contained in a plastic container. The one or more cooling elements provide for a cooling of the space formed by the carrier vessel laterally and on the underside and the one or more serving dishes on the upper side, and the surface on which the food rests is thus cooled. A dome is optionally also added to said setup in order to keep the food cool for longer, wherein the dome is for instance made of transparent glass or artificial glass.

In use of such a crockery system consisting of said setup it is however observed that great temperature differences occur, particularly in case of use without a dome, this both in relation to position on the serving dish(es), with for instance a cool central portion and a warmer edge portion, and to the period of use, with freezing temperatures on the serving dish(es) initially and temperatures which are already above 7° C. after 30 to 60 minutes, which entails a risk for food safety of food to be served cold, such as for instance meat and fish, and which additionally also entails the problem that, depending on the selection of the material of the serving dish(es), a different temperature range is achieved during use of the crockery.

### SUMMARY OF THE INVENTION

What is lacking in the prior art is crockery on the basis of the above stated combination of serving dish(es), cooling element(s) and carrier vessel without the use of a dome, which can keep the food, particularly meat and fish, on the serving dish(es) cooled for a longer period of time with a limited temperature variation, for instance limited to between 3 and 6° C., under standard conditions for more than 2 hours, this on the whole surface on which the food is placed, so not just the central portion for example, and with the option of achieving this optimal temperature range irrespective of the material selected for the serving dish.

Similar limitations are also observed for crockery based on a similar setup making use of heating elements, particularly also having the undesired great variation of the temperatures on the serving dish depending on the position of the food on the serving dish.

The present invention has for its object to provide a solution for at least several of the above stated problems and limitations.

In a first aspect the invention relates to a crockery system comprising a thermal buffer material and a phase-change material, this according to claims 1-12.

In a second aspect the invention relates to a method for producing a crockery system comprising a thermal buffer material and a phase-change material, this according to claims 13-24.

In a third aspect the invention relates to a method for using a crockery system comprising a thermal buffer material and a phase-change material, this according to claims 25-27.

### BRIEF DESCRIPTION OF THE FIGURES

The above stated, below and other advantageous properties and objectives of the invention will become more apparent, and the invention better understood, on the basis of the following detailed description when read in combination with the accompanying drawings and tables, in which:

FIG. 1 shows an exemplary embodiment of a crockery system comprising a thermal buffer material and a phase-change material according to the invention, wherein the optional carrier vessel is also shown;

FIG. 2 shows a table with specifications relating to example 1;

FIG. 3 shows a graph with measurement results relating to example 1;

FIG. 4 shows a schematic top view of a serving dish relating to example 2;

FIG. 5 shows a graph with measurement results relating to example 2;

FIG. 6 shows a graph with measurement results relating to example 3;

FIG. 7 shows a table with specifications relating to example 4;

FIG. 8 shows a graph with measurement results relating to example 4;

FIG. 9 shows a table with specifications relating to example 5;

FIG. 10 shows a graph with measurement results relating to example 5;

FIG. 11 shows a table with specifications relating to example 6;

FIG. 12 shows a graph with measurement results relating to example 6;

FIG. 13 shows a table with specifications relating to example 7;

FIGS. 14a and 14b show graphs with measurement results relating to example 7;

FIG. 15 shows a table with specifications relating to example 8; and

FIG. 16 shows a graph with measurement results relating to example 8.

### DETAILED EMBODIMENTS

The invention relates to a new crockery system 100 comprising thermal buffer material and phase-change material, more specifically comprising a setup assembled from one or more serving dishes 130, one or more form-flexible packages comprising liquid thermal buffer material 120 which make (thermal) contact on the upper side with the one or more serving dishes 130, and one or more optionally form-retaining packages comprising phase-change material 110 which make (thermal) contact on the upper side with the one or more packages comprising thermal buffer material 120, optionally in combination with a carrier system 140, for instance a carrier vessel, in which the one or more packages comprising phase-change material 110 can be placed and on which the one or more serving dishes 130 can be placed, with therebetween the one or more packages comprising thermal buffer material 120 which make (thermal) contact on the upper side with the one or more serving dishes 130 and make (thermal) contact on the underside with the one or more packages comprising phase-change material 110.

Several advantages are achieved by applying the package with thermal buffer material 120, these being a long period of cold or heat on the surface of the serving dish(es) with limited variation of the temperature as a function of time, and this over a large part of the surface of the serving dish(es) 130, and also with limited variation of the temperature as a function of the position on the surface of the serving dish(es) 130.

The invention also relates to an embodiment wherein the material of the form-flexible package comprising liquid thermal buffer material 120 preferably consists of plastic which is not very permeable or is impermeable to water, salt, alcohols and esters.

The invention also relates to an embodiment wherein the liquid thermal buffer material preferably comprises water, salt, alcohols or esters, and preferably also comprises a gelling agent such as for instance sodium polyacrylate (superabsorbent or SAP).

The invention also relates to an embodiment wherein the material of the package comprising phase-change material 110 preferably consists of form-retaining plastic which is not very permeable or is impermeable to water, salt, alcohols and esters.

The invention also relates to an embodiment wherein the phase-change material comprises water, salt, alcohols or esters, and preferably also comprises a gelling agent.

The invention also relates to phase-change materials with a melting point in the temperature range of 35 to 95° C.

The invention also relates to serving dishes 130, the material of which is preferably selected from the group of stainless steel, porcelain, stoneware, tempered glass, glass and plastic.

The liquid thermal buffer material and the plastic package preferably have a thermal conductivity of at least 0.1 W/(m·K).

The difference in the melting points of the thermal buffer material and the phase-change material preferably amounts to less than 10° C., more preferably less than 7° C., still more preferably less than 4° C.

The invention also relates to a method for producing a crockery system 100 comprising one or more serving dishes 130, one or more form-flexible packages comprising liquid thermal buffer material 120, and one or more optionally form-retaining packages comprising phase-change material 110, with the one or more packages comprising thermal buffer material 120 making thermal contact on the upper side with the one or more serving dishes 130 and making thermal contact on the underside with the one or more packages comprising phase-change material 110, which comprises the steps of:
packaging thermal buffer material in a form-flexible package;
packaging phase-change material in an optionally form-retaining package;
arranging the form-flexible package comprising thermal buffer material on the optionally form-retaining package comprising phase-change material and arranging the serving dish on the form-flexible package comprising thermal buffer material.

The invention additionally also comprises a method comprising the steps of:
placing the optionally form-retaining package comprising phase-change material in a carrier system;
placing the serving dish on a carrier system.

The invention also relates to a method wherein the material of the form-flexible package comprising liquid thermal buffer material 120 preferably consists of plastic which is not very permeable or is impermeable to water, salt, alcohols and esters.

The invention also relates to a method wherein the liquid thermal buffer material preferably comprises water, salt, alcohols or esters.

The invention also relates to a method wherein the liquid thermal buffer material comprises a gelling agent, such as for instance sodium polyacrylate (superabsorbent or SAP).

The invention also relates to the a method wherein the material of the package comprising phase-change material 110 preferably consists of form-retaining plastic which is not very permeable or is impermeable to water, salt, alcohols and esters.

The invention also relates to a method wherein the phase-change material preferably comprises water, salt, alcohols or esters, and preferably also comprises a gelling agent.

The invention also relates to a method wherein the phase-change material preferably has a melting point in the temperature range of 35 to 95° C.

The invention also relates to a method wherein the phase-change material comprises a gelling agent.

The invention also relates to a method wherein the one or more serving dishes 130 comprise material preferably selected from the group of stainless steel, porcelain, stoneware, (tempered) glass or plastic.

The invention also relates to a method wherein the liquid thermal buffer material and the plastic package preferably have a thermal conductivity of at least 0.1 W·m⁻¹·K⁻¹.

The invention also relates to a method wherein the difference in the melting points of the thermal buffer material and the phase-change material preferably amounts to less than 10° C.

The invention also relates to a method for use of a crockery system 100 comprising one or more serving dishes 130, one or more form-flexible packages comprising liquid thermal buffer material 120, preferably with a melting point in the range of −5° C. to 5° C., and one or more optionally form-retaining packages comprising phase-change material 110, preferably with a melting point in the range of −15° C. to 5° C., wherein:
one or more optionally form-retaining packages comprising phase-change material 110 are placed in a freezer until the phase-change material has solidified;
one or more form-flexible packages comprising liquid thermal buffer material 120 are optionally cooled in the refrigerator;
one or more form-flexible packages comprising liquid thermal buffer material 120 are placed with thermal contact on one or more optionally form-retaining packages comprising the solidified phase-change material;
one or more serving dishes 130, with or without food, are optionally cooled in the refrigerator;
one or more serving dishes 130, with or without food, are placed on one or more form-flexible packages comprising liquid thermal buffer material 120, these themselves being placed with thermal contact on one or more optionally form-retaining packages comprising the solidified phase-change material 110;

The invention also relates to a method for use of a crockery system 100 comprising one or more serving dishes 130, one or more form-flexible packages comprising liquid thermal buffer material 120, preferably with a melting point in the range of 5° C. to 15° C., and one or more optionally form-retaining packages comprising phase-change material 110, preferably with a melting point in the range of 5° C. to 15° C., wherein:
one or more optionally form-retaining packages comprising phase-change material 110 are placed in a refrigerator until the phase-change material has solidified;
one or more form-flexible packages comprising liquid thermal buffer material 120 are optionally cooled in the refrigerator;
one or more form-flexible packages comprising liquid thermal buffer material 120 are placed with thermal contact on one or more optionally form-retaining packages comprising the solidified phase-change material 110;
one or more serving dishes 130, with or without food, are optionally cooled in the refrigerator;
one or more serving dishes 130, with or without food, are placed on one or more form-flexible packages comprising liquid thermal buffer material 120, these themselves being placed with thermal contact on one or more optionally form-retaining packages comprising the solidified phase-change material 110;

The invention also relates to a method for use of a crockery system 100 comprising one or more serving dishes 130, one or more form-flexible packages comprising liquid thermal buffer material 120 and one or more optionally form-retaining packages comprising phase-change material 110, preferably with a melting point in the range of 35° C. to 95° C., wherein:
one or more optionally form-retaining packages comprising phase-change material 110 are heated until the phase-change material has melted;
one or more form-flexible packages comprising liquid thermal buffer material 120 are optionally heated;
one or more form-flexible packages comprising liquid thermal buffer material 120 are placed with thermal contact on one or more optionally form-retaining packages comprising the solidified phase-change material 110;
one or more serving dishes 130, with or without food, are optionally heated;
one or more serving dishes 130, with or without food, are placed on one or more form-flexible packages comprising liquid thermal buffer material 120, these themselves being placed with thermal contact on one or more optionally form-retaining packages comprising the solidified phase-change material 110;

The following describes the invention on the basis of non-limitative examples which illustrate the invention and which are neither intended to limit nor should be interpreted as limiting the scope of the invention.

For advantages and technical effects of elements described below in the examples reference is made to the advantages and technical effects of corresponding elements described above in the detailed description.

### Example 1

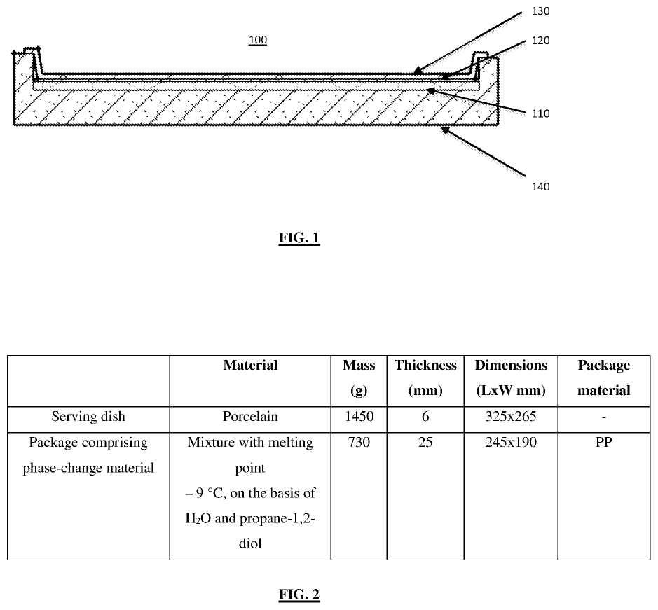

The serving dish 130 is pre-cooled in the refrigerator (set to 5° C.) and the package comprising phase-change material 110 in the freezer (set to −18° C.), specification hereof as described in the table of FIG. 2. At the start of the test, the package comprising phase-change material 110 is placed in the stainless steel carrier vessel 140, which is closed by the serving dish 130. This results in an air layer of about 3 mm between the package comprising phase-change material and the serving dish, as shown in FIG. 1.

The temperature is measured in the centre of serving dish 130 and in the centre of the food. The food used in this test are slices of mild cheese (100 g, 4 slices), as are typically served in such a setup.

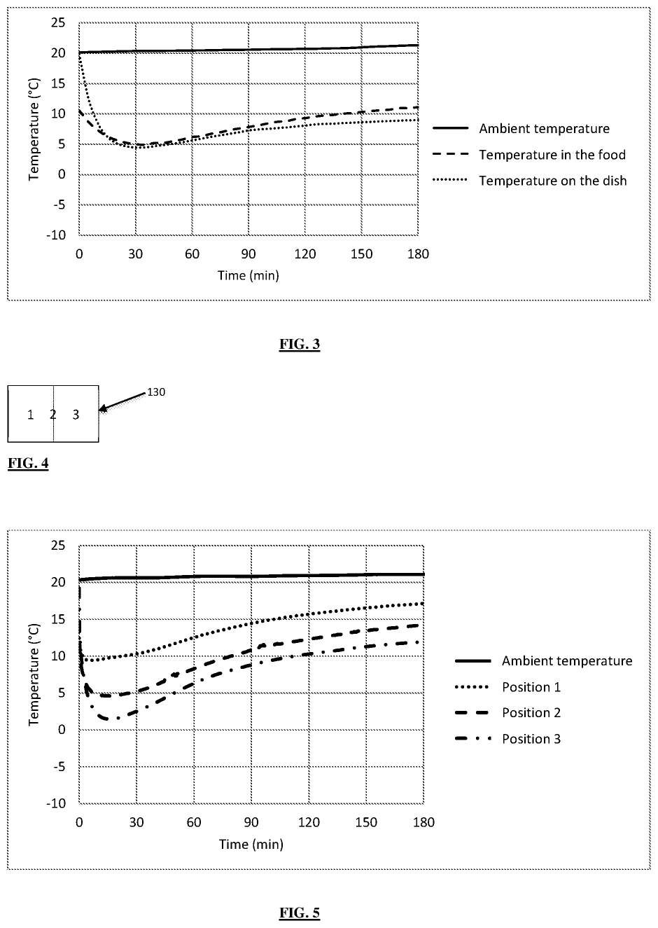

The graph of FIG. 3 shows the results for the following, this being one serving dish 130 supporting on a carrier vessel 140 which is provided with a package comprising phase-change material 110 which provides for cooling of the space formed by the carrier vessel 140 laterally and on the underside and the serving dish 130 on the upper side. There is found to be a limited cooling effect on the serving dish 130, this due to the cooling effect of the package comprising phase-change material 110 on the air in the space formed by the lateral closure of carrier vessel 140 and the upper closure by serving dish 130 itself. This effect is however limited to just 90 minutes, wherein it can be concluded that from this specific time on the temperatures will lie above the temperatures safe for meat and fish products.

### Example 2

In this test the temperature is determined at three positions on the serving dish. In the centre (position 2) of the serving dish and additionally also halfway to the centre the serving dishes (positions 1 and 3), as indicated in FIG. 4.

As in Example 1, the serving dish 130 is pre-cooled at 5° C. in the refrigerator and the package comprising phase-change material 110 is activated at −18° C. in the freezer, specification hereof corresponding to Example 1, see the table of FIG. 2. In this example the distance between serving dish 130 and the package comprising phase-change material 110 also amounts to about 3 mm.

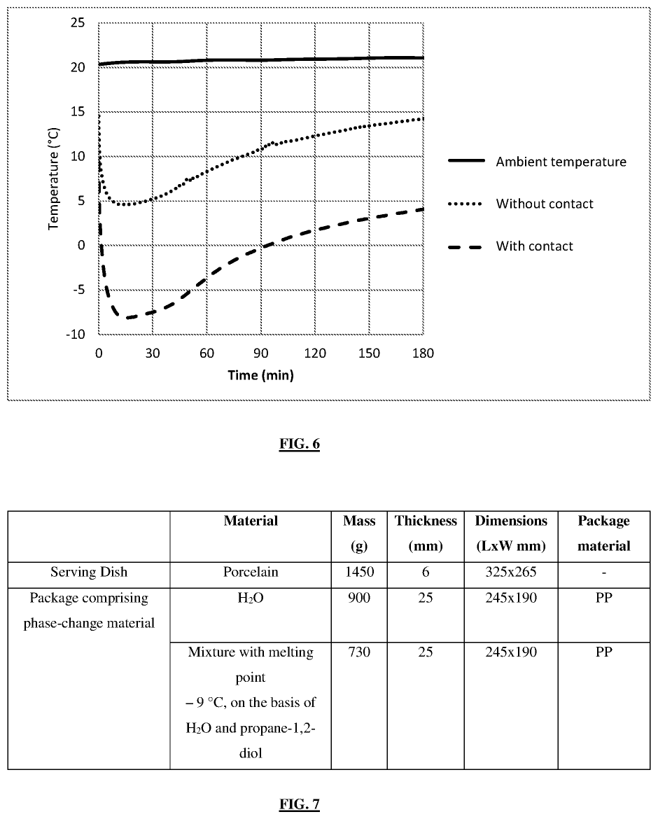

The graph of FIG. 5 shows the variation of the position on the serving dish 130 supporting on a carrier vessel 140 which is provided with a package comprising phase-change material 110. It can be stated here that the variation over this serving dish 130 in respect of position is great, whereby the food served may be in freezing state at some positions while the same type of food may be above the temperatures safe for food at other positions on this serving dish.

### Example 3

In this example a similar test is performed as in Example 2, with the difference that the package comprising phase-change material 110 is insulated at the bottom with cardboard. This also results in direct contact between the package comprising phase-change material 110 and the serving dish 130. The serving dish 130 is pre-cooled at 5° C. in the refrigerator, and the package comprising phase-change material is activated in a freezer at −18° C. In this example the temperature measurement is performed directly on the centre of the dish.

The graph of FIG. 6 shows the results for one serving dish 130 supporting on a carrier vessel 140 which is provided with a package comprising phase-change material 110, which provides for cooling of the space formed by the carrier vessel 140 laterally and on the underside and the serving dish 130 on the upper side. A distinction is made here between the above stated system wherein, on the one hand, there is no direct contact between the package comprising phase-change material 110 and the serving dish 130 and, on the other, there is direct thermal contact. From this, we can conclude that the air layer in the experiment without direct thermal contact has a retardant effect. This ensures that the amount of heat extracted from serving dish 130 is distributed over a longer period of time, whereby big freezing points are prevented.

### Example 4

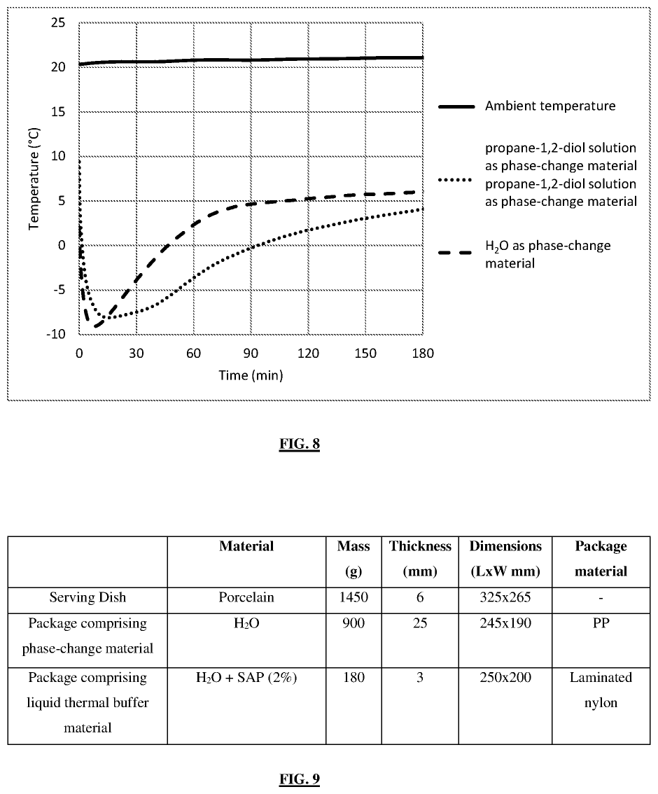

In this example a similar test is performed as in Example 3, with the difference that a different phase-change material is tested in order to verify whether negative temperatures can be avoided, specifications as in the table of FIG. 7. As in Example 3, the underside is insulated using cardboard, whereby there is here also direct contact between the package comprising phase-change material 110 and the serving dish 130. The serving dish 130 is pre-cooled at 5° C. in the refrigerator, and the package comprising phase-change material 110 is activated in a freezer at −18° C. The temperature measurement is performed directly on the centre of the dish.

The graph of FIG. 8 shows the results for the following, this being one serving dish 130 supporting on a carrier vessel 140 which is provided with a package comprising phase-change material 110, which provides for cooling of the space formed by the carrier vessel 140 laterally and on the underside and the serving dish 130 on the upper side. A distinction is made here between the above stated system wherein, on the one hand, a phase-change material with a negative melting point is used and, on the other, a phase-change material with a melting point of 0° C. It can be concluded that it may be possible to limit the negative temperatures in terms of time of application, for instance 45 minutes and not for instance 90 minutes, but, as in example 3, the negative temperatures cannot initially be avoided due to the specific heat capacity of the phase-change material.

### Example 5

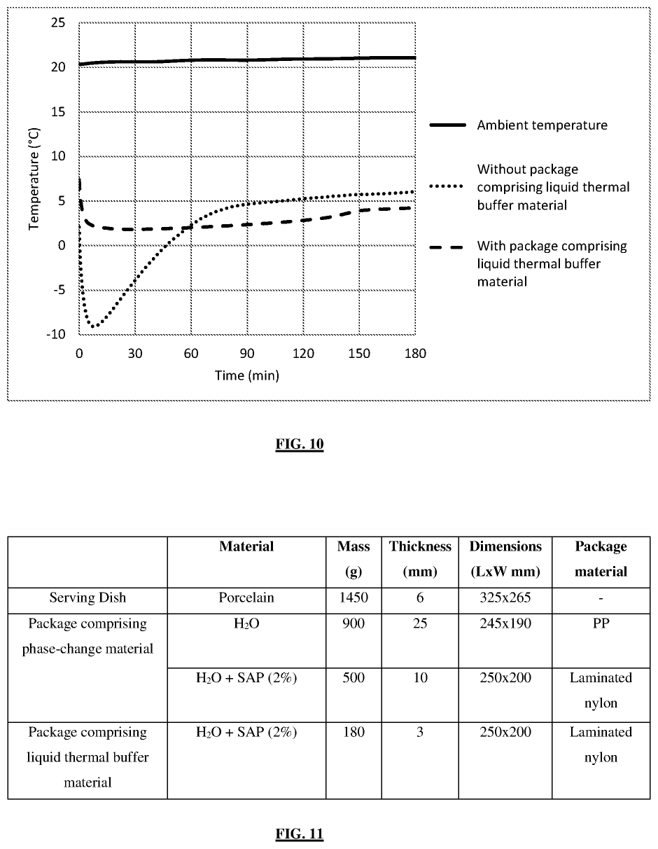

In this example a similar test is performed as in Example 4, with the difference that a third element is added here in order to avoid negative temperatures, this being a package comprising liquid thermal buffer material 120, which is positioned between the serving dish 130 and the package comprising phase-change material 110, and which is in direct thermal contact with both serving dish 130 and the package comprising phase-change material 110, specification as in the table of FIG. 9. As in Examples 3 and 4, the underside is insulated using cardboard. The serving dish 130 is pre-cooled at 5° C. in the refrigerator, and the package comprising phase-change material 110 is activated in a freezer at −18° C. The package comprising liquid thermal buffer material 120 is stored at ambient temperature. The temperature measurement is performed directly on the centre of serving dish 130.

The graph of FIG. 10 shows the results for the following, this being one serving dish 130 supporting on a carrier vessel 140 which is provided with a package comprising phase-change material 110, which provides for cooling of the space formed by the carrier vessel 140 laterally and on the underside and the serving dish 130 on the upper side. A distinction is made here between the above stated system wherein, on the one hand, there is direct contact between the package comprising phase-change material 110 and serving dish 130 and, on the other, a liquid thermal buffer material 120 is used to bring the serving dish 130 and the package comprising phase-change material 110 into contact with each other. From this, it can be concluded that no negative temperatures occur, specifically owing to application of the liquid thermal buffer material 120. The specific heat capacity of this material 120 suffices to sufficiently inhibit the energy flow from serving dish 130.

### Example 6

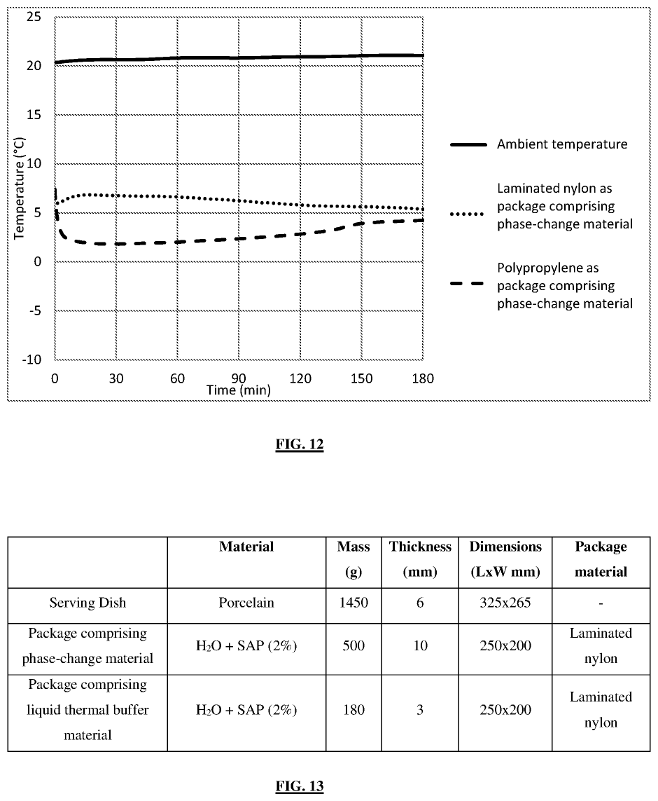

In this example a similar test is performed as in Example 5, with the difference that the package and the quantity of the package comprising phase-change material 110 are altered specifically, specification as in the table of FIG. 11. As in previous examples, the underside is insulated using cardboard. The serving dish 130 is pre-cooled at 5° C. in the refrigerator, and the package comprising phase-change material 110 is activated in a freezer at −18° C. The package comprising thermal buffer material 120 is here also stored at ambient temperature. The temperature measurement is performed directly on the centre of dish 130.

The graph of FIG. 12 shows the results for the following, this being one serving dish 130 supporting on a carrier vessel 140 which is provided with a package comprising phase-change material 110, which provides for cooling of the space formed by the carrier vessel 140 laterally and on the underside and the serving dish 130 on the upper side. A distinction is made here between the system wherein use is made on the one hand of a package comprising phase-change material 110 of polypropylene with a thickness of 25 mm and, on the other, a package comprising phase-change material 110 of laminated nylon with a thickness of 10 mm. It can be concluded from the determined temperature profiles that by applying a package comprising liquid thermal buffer material 120 a smaller quantity of phase-change material in the package comprising phase-change material 110 may be necessary to achieve a temperature profile safe for food.

### Example 7

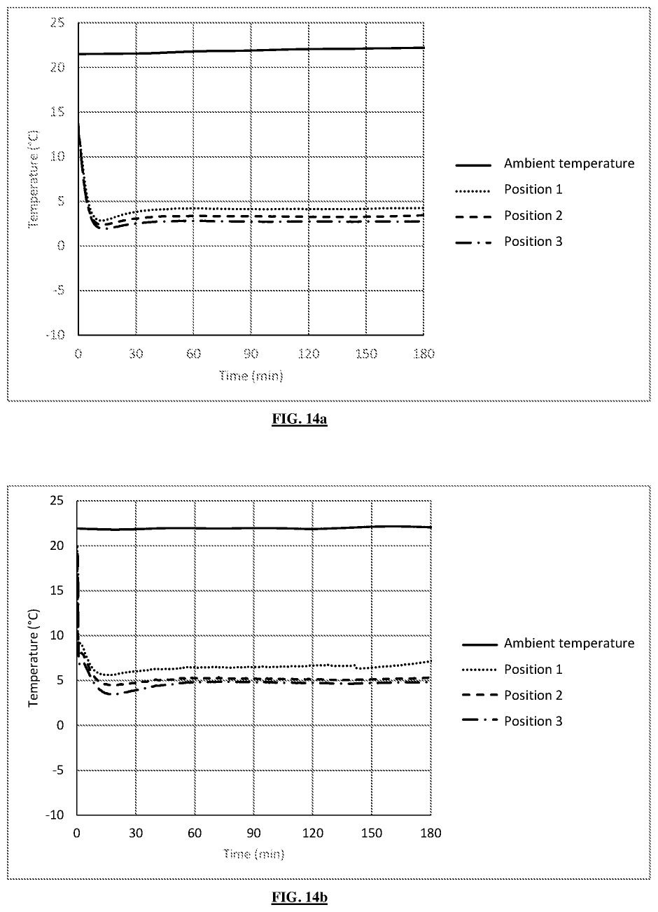

As package comprising phase-change material 110 use is in this example made of a package of laminated nylon which comprises the phase-change material (activated at −18° C.) in combination with a thinner package comprising thermal buffer material 120, which comprises the same material but is not activated, further specification as in the table of FIG. 13. The serving dish 130 is once again pre-cooled in the refrigerator.

Use is not made here of the metal vessel 140 but of a metal plate. Just as metal vessel 140, this is disposed such that there is no direct contact between the cooling system and the table.

At the start, the activated package comprising phase-change material 110 is placed on the plate. The non-activated thinner package comprising thermal buffer material 120 is placed thereon. The serving dish 130 then goes thereon.

The temperature is once again measured at three positions, as in Example 2.

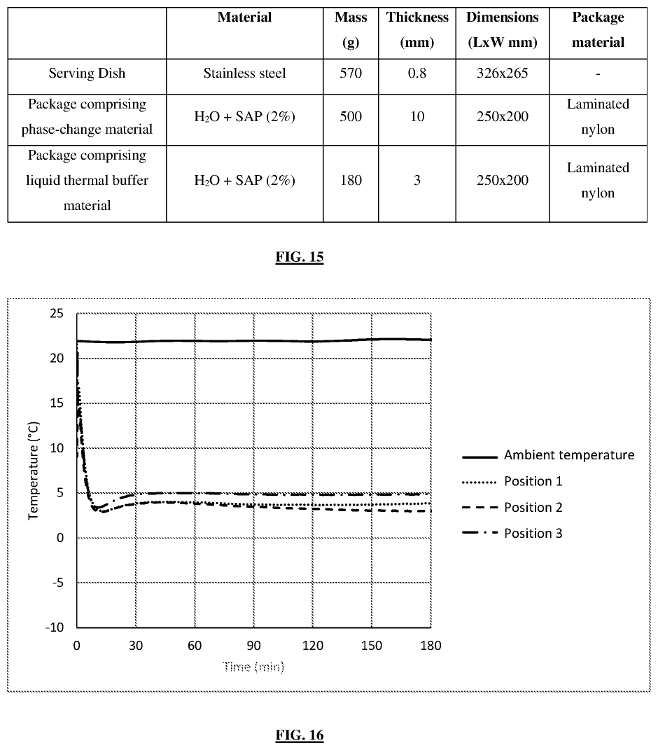

The graphs of FIGS. 14a (without food) and 14b (with food, 100 g sliced cheese as in Example 1) show the results of the crockery system 100 comprising thermal buffer material 120 and phase-change material 110 applied to one or more serving dishes 130 supporting on a carrier device 140. It can be concluded that the temperature variations can be limited to 3 to 6° C. by applying the new crockery system 100 comprising thermal buffer material 120 and phase-change material 110. It can additionally be concluded on the basis of these results that with this above stated system a cold period of 180 minutes, within which the food temperature lies in a safe temperature range, can be guaranteed.

### Example 8

This example is similar to Example 5, although the material of the serving dish 130 changes to stainless steel, further specifications as in the table of FIG. 15.

The graph of FIG. 16 illustrates the result of the crockery system 100 comprising thermal buffer material 120 and phase-change material 110 being applied to one or more serving dishes 130 supporting on a carrier vessel 140, with the specific selection of a serving dish 130 of stainless steel. It can be concluded that the crockery comprising thermal buffer material 120 and phase-change material 110 provides for a minimum of temperature variations of the whole surface, whereby it is possible to give a guarantee in respect of the safety of the food present on this plate or dish 130. In addition, it is possible to decide that the crockery system as cooling system ensures that the temperature lies within a range safe for food.

The skilled person will appreciate that the invention is not limited to the above described embodiments and examples, and that many modifications and variants are possible within the scope of the invention, which is defined solely by the following claims.

1-20. (canceled)

21. Crockery system comprising at least one serving dish, at least one form-flexible package comprising liquid thermal buffer material, and at least one package comprising phase-change material, wherein the at least one package comprising thermal buffer material is in thermal contact on the upper side thereof with the at least one serving dish and is in thermal contact on the underside thereof with the at least one package comprising phase-change material.

22. Crockery system according to claim 21, comprising a carrier device configured for receiving the at least one package comprising phase-change material therein and for receiving the at least one serving dish thereon.

23. Crockery system according to claim 21, wherein the at least one form-flexible package comprising liquid thermal buffer material is manufactured from plastic material which is hardly permeable to water, salt, alcohols, and esters, or is impermeable to water, salt, alcohols and esters.

24. Crockery system according to claim 21, wherein the liquid thermal buffer material comprises water, salt, alcohols and/or esters.

25. Crockery system according to claim 21, wherein the liquid thermal buffer material comprises a gelling agent.

26. Crockery system according to claim 25, wherein the gelling agent is sodium polyacrylate.

27. Crockery system according to claim 21, wherein the package comprising phase-change material is manufactured from form-retaining material.

28. Crockery system according to claim 27, wherein the package comprising phase-change material is manufactured from form-retaining plastic material which is hardly permeable to water, salt, alcohols, and esters, or is impermeable to water, salt, alcohols and esters.

29. Crockery system according to claim 21, wherein the phase-change material comprises water, salt, alcohols and/or esters.

30. Crockery system according to claim 21, wherein the phase-change material has a melting point of between 35° C. and 95° C.

31. Crockery system according to claim 21, wherein the phase-change material comprises a gelling agent.

32. Crockery system according to claim 21, wherein the at least one serving dish comprises at least one material selected from the group of stainless steel, porcelain, stoneware, glass, tempered glass and plastic.

33. Crockery system according claim 21, wherein the liquid thermal buffer material has a thermal conductivity of at least 0.1 W/(m·K).

34. Crockery system according to claim 21, wherein a difference between the melting points of the thermal buffer material and the phase-change material amounts to less than 10° C., more preferably less than 7° C., still more preferably less than 4° C.

35. Crockery system according to claim 21, wherein the thermal buffer material and the phase-change material have the same melting point.

36. Method for producing a crockery system comprising at least one serving dish, at least one form-flexible package comprising liquid thermal buffer material, and at least one optionally form-retaining package comprising phase-change material, wherein the at least one package comprising thermal buffer material is in thermal contact on the upper side thereof with the at least one serving dish and is in thermal contact on the underside thereof with the at least one package comprising phase-change material, characterized in that the method comprises the steps of:
packaging thermal buffer material in a form-flexible package;
packaging phase-change material in a package;
arranging the form-flexible package comprising thermal buffer material on the package comprising phase-change material and arranging the serving dish on the form-flexible package comprising thermal buffer material.

37. Method according to claim 36, characterized in that the method comprises the steps of:
placing the package comprising phase-change material in a carrier system;
placing the serving dish on the carrier system.

38. Method for use of the crockery system according to claim 21, wherein:
the at least one package comprising phase-change material, preferably with a melting point in the range of −15° C. to 5° C., is placed in a freezer until the phase-change material has solidified;
the at least one form-flexible package comprising thermal buffer material, preferably with a melting point in the range of −5° C. to 5° C., is optionally cooled;
the at least one form-flexible package comprising liquid thermal buffer material is placed in thermal contact on the at least one package comprising the solidified phase-change material;
the at least one serving dish, with or without food thereon, is optionally cooled;
the at least one serving dish, with or without food thereon, is placed on the at least one form-flexible package comprising liquid thermal buffer material, this itself being placed in thermal contact on the at least one package comprising the solidified phase-change material.

39. Method for use of the crockery system according to claim 21, wherein:
the at least one package comprising phase-change material, preferably with a melting point in the range of 5° C. to 15° C., is cooled until the phase-change material has solidified;
the at least one form-flexible package comprising liquid thermal buffer material, preferably with a melting point of 5° C. to 15° C., is optionally cooled;
the at least one form-flexible package comprising liquid thermal buffer material is placed in thermal contact on the at least one package comprising the solidified phase-change material;
the at least one serving dish, with or without food thereon, is optionally cooled;
the at least one serving dish, with or without food thereon, is placed on the at least one form-flexible package comprising liquid thermal buffer material, this itself being placed in thermal contact on the at least one package comprising the solidified phase-change material.

40. Method for use of the crockery system according to claim 21, wherein:
the at least one package comprising phase-change material, preferably with a melting point in the range of 35° C. to 95° C., is heated until the phase-change material has melted;
the at least one form-flexible package comprising liquid thermal buffer material is optionally heated;
the at least one form-flexible package comprising liquid thermal buffer material is placed in thermal contact on the at least one package comprising the solidified phase-change material;
the at least one serving dish, with or without food thereon, is optionally heated;
the at least one serving dish, with or without food thereon, is placed in thermal contact on the at least one form-flexible package comprising liquid thermal buffer material, this itself being placed in thermal contact on the at least one package comprising the solidified phase-change material.
